(19) United States
(12) Patent Application Publication
(10) Pub. No.: US 2006/0194052 A1
(43) Pub. Date: Aug. 31, 2006

(54) Insulated wire

(75) Inventors: Yong Hoon Kim, Tokyo (JP); Hideo Fukuda, Tokyo (JP)

Correspondence Address: BIRCH STEWART KOLASCH & BIRCH, PO BOX 747, FALLS CHURCH, VA, 22040-0747, US

(73) Assignee: THE FURUKAWA ELECTRIC CO., LTD.

(21) Appl. No.: 11/398,567

(22) Filed: Apr. 6, 2006

Related U.S. Application Data
(63) Continuation of application No. PCT/JP04/18083, filed on Nov. 29, 2004.

(30) Foreign Application Priority Data
Dec. 4, 2003 (JP) 2003-406542

(51) Int. Cl. B32B 27/00

(52) U.S. Cl. 428/383

(57) ABSTRACT

An insulated wire, which is coated, on a conductor, with a thin insulating layer composed of a resin dispersion, wherein the resin dispersion contains: a polyester-series resin (A) in a continuous phase; and a core-shell polymer (B) in a dispersed phase, in which the core-shell polymer (B) has a rubber-like core produced from an acrylate, a methacrylate or a mixture thereof and has an outer shell containing a vinyl-series homopolymer or copolymer.

### TECHNICAL FIELD

The present invention relates to an insulated wire.

### BACKGROUND ART

Regarding an insulated wire obtained by extrusion-coating a linear polyester resin composed of an aromatic dicarboxylic acid residue and an aliphatic glycol, for example a polyethylene terephthalate resin (hereinafter referred to as PET) or a polybutylene terephthalate resin, if the insulated wire is left under the environment of a temperature at 30° C. or more, degradation of dielectric breakdown voltage caused by occurrence of crazing is confirmed. As means for solving this problem, there is proposed that a stable dielectric breakdown voltage of an insulated wire is obtained, by blending 1 to 15% by mass of an ethylene-series copolymer containing a carboxylic acid having good compatibility with the polyester-series resin.

On the other hand, in recent years, high-frequency input voltage has been used for the switching power supply for electric or electronic devices, machinery and tools, and thus there has been a demand for improvement in high-frequency insulating characteristics. In response to this demand, it has been proposed that insulating coatings should contain particles, for example, of triiron tetraoxide, aluminum hydroxide, talc, barium compounds, silicon dioxide, alumina, calcium carbonate, synthetic mica, clay, titanium oxide, or any combination thereof. However, such particles can produce a brittle insulating coating and a coarse coating surface, such that snagging can occur in the wire winding process; the resistance can be high when the wire is running; abrasion of or damage to the insulating coating, or breaking of the wire, can easily occur; and the insulating coating, and thus the wire, can have reduced flexibility. Therefore, the insulating coatings can easily crack or craze in various processes involving winding or bending, and the outer appearance of the wire can be degraded. For such problems, conventional insulated wires having an extruded polyester resin coating do not sufficiently meet the above demand.

Other and further features and advantages of the invention will appear more fully from the following description.

### DISCLOSURE OF THE INVENTION

According to the present invention, there is provided the following means:

(1) An insulated wire, which is coated, on a conductor, with a thin insulating layer composed of a resin dispersion,

wherein the resin dispersion comprises:

a polyester-series resin (A) in a continuous phase; and

a core-shell polymer (B) in a dispersed phase, in which the core-shell polymer (B) has a rubber-like core produced from an acrylate, a methacrylate or a mixture thereof and has an outer shell comprising a vinyl-series homopolymer or copolymer;

(2) The insulated wire according to item (1), wherein the polyester-series resin (A) is a polymer obtained by condensation reaction of a dicarboxylic acid with a diol;

(3) The insulated wire according to item (1) or (2), wherein the core-shell polymer (B) has a rubber-like core comprising an alkyl acrylate polymer, and has an outer shell comprising an alkyl methacrylate polymer; and

(4) The insulated wire according to any one of items (1) to (3), wherein the resin dispersion contains 1 to 20 mass parts of the core-shell polymer (B), to 100 mass parts of the polyester-series resin (A).

Herein, the term “alkyl” may be any of a strait-chain, branched, or cyclic one, and means to include all of these.

### BEST MODE FOR CARRYING OUT THE INVENTION

The present invention is explained in detail below.

The thin insulating layer in the insulated wire of the present invention, is composed of the resin dispersion, which comprises the component (A) in the continuous phase and the component (B) in the dispersed phase, the component (B) of the core-shell polymer being uniformly and finely dispersed in the component (A) of the polyester-series resin.

The polyester-series resin (A) that can be used in the present invention is preferably a polymer obtained by condensation reaction of a dicarboxylic acid with a diol.

Examples of the carboxylic acid component to constitute the resin (A) include aromatic dicarboxylic acids, such as terephthalic acid, isophthalic acid, naphthalene dicarboxylic acid, diphenyldicarboxylic acid, diphenylsulfondicarboxylic acid, diphenyletherdicarboxylic acid, or an alkyl ester or acid halide thereof, bis(p-carboxyphenyl)methane, 4,4′-sulfonyldibenzoic acid; aliphatic dicarboxylic acids, such as adipic acid, azelaic acid, and sebacic acid; and the like. The dicarboxylic acid may be a mixture of two or more kinds thereof.

Examples of the diol component include ethylene glycol, propylene glycol, tetramethylene glycol, pentamethylene glycol, 2,2-dimethyltrimethylene glycol, hexamethylene glycol, decamethylene glycol, p-xylene glycol, cyclohexanedimethanol, poly(ethtyleneoxide) glycol, poly(1,2-propyleneoxide) glycol, poly(1,3-propyleneoxide) glycol, poly(tetramethyleneoxide) glycol, and the like. The diol may be a mixture of two or more kinds thereof.

Representative examples of the polyester-series resin (A) include polybutylene terephthalate, polyethylene terephthalate, polyethylene naphthalate, polybutylene naphthalate, as well as copolymer polyesters, such as polyethylene isophthalate/terephthalate, polybutylene isophthalate/terephthalate, polyethylene terephthalate/naphthalate, polybutylene terephthalate/naphthalate, and the like. Especially, polyethylene terephthalate resin is preferable. There are commercially available resins including, for example, Vylopet (trade name, manufactured by Toyobo Co., Ltd.), Bellpet (trade name, manufactured by Kanebo, Ltd.), and Teijin PET (trade name, manufactured by Teijin Ltd.). The polyester-series resin (A) may be a single component or a mixture of two or more kinds thereof.

The core-shell polymer resin (B) that can be used in the present invention, means a core-shell polymer that has a rubber-like core produced from an acrylate, a methacrylate or a mixture thereof (preferably a rubber-like core composed of an alkyl acrylate polymer), and that has an outer shell of a vinyl-series polymer or copolymer (preferably an outer shell composed of an alkyl methacrylate polymer). In the core-shell polymer resin (B) for use in the present invention, the core is preferably an acrylic rubber core, which is obtained by polymerizing an alkyl acrylate having an alkyl group of 1 to 6 carbon atoms, which has a Tg lower than about 10° C., and which contains a crosslinking monomer and/or a grafting monomer, in addition to the alkyl acrylate. In particular, the alkyl acrylate is preferably n-butyl acrylate.

The crosslinking monomer is a multi-ethylenically unsaturated monomer having a plurality of addition-polymerizable reactive groups all of which can be polymerized at substantially the same reaction rate.

Examples of the crosslinking monomer that can be preferably used in the present invention, include butylene diacrylate and butylene dimethacrylate; poly(acrylate ester) or poly(methacrylate ester) of polyol, such as trimethylolpropane trimethacrylate; divinylbenzene and trivinylbenzene; and vinyl acrylate and vinyl methacrylate. In particular, the crosslinking monomer is preferably butylene diacrylate.

The grafting monomer is a multi-ethylenically unsaturated monomer having a plurality of addition-polymerizable reactive groups, at least one of which can be polymerized at a polymerization rate substantially different from the rate at which at least one of the other reactive groups can be polymerized. The grafting monomer has a function of leaving an unsaturated group in the elastomer phase, specifically on or near the surfaces of the elastomer particles (the rubber-like cores), particularly in a later polymerization step. Therefore, when a stiff thermoplastic shell layer (hereinafter also simply referred to as “shell layer” or “final-step part”) is subsequently formed by polymerization on the surface of the elastomer (the rubber-like core), the addition-polymerizable unsaturated reactive group provided and left by the grafting monomer takes part in the shell layer-forming reaction. As a result, at least a part of the shell layer can be chemically attached to the surface of the elastomer.

Examples of the grafting monomer that can be preferably used in the present invention, include alkyl group-containing monomers of allyl esters of ethylenically unsaturated dibasic acids, such as allyl acrylate, allyl methacrylate, diallyl maleate, diallyl fumarate, diallyl itaconate, acidic allyl maleate, acidic allyl fumarate, and acidic allyl itaconate. In particular, the grafting monomer is preferably allyl methacrylate or diallyl maleate.

The outer shell-forming monomer that can be used in the present invention (hereinafter simply referred to as “the monomer for the final-step part” or “the monomer for the shell layer”), is a monomer capable of forming a vinyl-series homopolymer or copolymer. Specific examples of the monomer for the final-step part, include methacrylates, acrylonitrile, alkyl acrylates, alkyl methacrylates, dialkylaminoalkyl methacrylates, and styrene. The above monomer for the final-step part may be used singly, or two or more of the above monomers may be used in the form of a mixture. The monomer for the final-step part is preferably a methacrylate having an alkyl group of 1 to 16 carbon atoms, most preferably an alkyl methacrylate having an alkyl group of 1 to 4 carbon atoms.

The core-shell polymer resin (B) may be produced by any method, and the production method is not particularly limited. The core-shell polymer resin (B) is preferably produced using an emulsion polymerization method.

One example of the core-shell polymer (B) that can be preferably used in the present invention, has only two step parts: the first-step part (i.e. the rubber-like core) which is a product of polymerization of a monomer system comprising butyl acrylate, as well as butylene diacrylate as a crosslinking agent, and allyl methacrylate or allyl maleate as a grafting agent; and the final-step part (i.e. the shell) of a methyl methacrylate polymer. For the purpose of improving the dispersibility in the polyester-series resin (A), the shell surface may have at least one functional group selected from the group consisting of an epoxy group, an oxazoline group, an amine group, and a maleic anhydride group.

Commercially available products of the two-step core-shell polymers, as mentioned in the above, include PARALOID EXL-2313, EXL-2314, and EXL-2315 (all registered trademarks) manufactured by Kureha Chemical Industry Co., Ltd., but the present invention is not limited to these.

In the present invention, the ratio in thickness of the core part and the shell part of the core-shell polymer (B), is not particularly limited, and the thickness ratio may be general one of the core part to the shell part formed in a usual manner by, for example, an emulsion polymerization method.

The core-shell polymer (B) for use in the present invention preferably has an average particle diameter of 50 to 700 nm, more preferably 100 to 500 nm.

In the present invention, the amount of the core-shell polymer (B) to be contained, is preferably from 1 to 20 parts by mass, more preferably from 2 to 15 parts by mass, to 100 parts by mass of the polyester resin (A). If the amount of (B) component is too small, it is difficult to exhibit the effects of the present invention, while the too large amount may lead to degradation in heat resistance.

Further, the resin dispersion for use in the present invention can be obtained by melting and blending the polyester-series resin (A) and the core-shell polymer (B), by using a usual mixer, such as a twin screw extruder and a co-kneader.

Further, as required, a lubricant, for example, stearic acids, waxes, and low-molecular weight polyethylenes; or a coloring agent, can be added to the resin dispersion. By adding the lubricant, it is also possible to improve processability including decrease of conductor tensile strength during extrusion-coating a thin film.

In the present invention, the thickness of one thin insulating layer is not particularly limited, and it is preferably 10 to 100 μm, more preferably 20 to 60 μm.

Further, in the present invention, in order to strengthen mechanical properties, two or three coating layers of a polyamide-series resin can be applied on the side of the outer periphery of one or two coating layer(s) formed with a thin layer composed of the resin dispersion according to the present invention. In this case, examples of the polyamide resin include 6,6-nylon, 6-nylon, 6,10-nylon, polyhexamethylene terephthalamide, polynonamethylene terephthalamide, and the like.

The insulated wire of the present invention can suppress degradation of dielectric breakdown voltage caused by occurrence of crazing, with the passage of time, and it is excellent in high-frequency insulating properties.

### EXAMPLES

The present invention will be described in more detail based on examples given below, but the invention is not meant to be limited by these.

The resin dispersions in the examples below each were obtained by mixing components thereof using a 30-mmφ twin-screw extruder for kneading.

### Example 1

Five parts by mass of a core-shell polymer resin (PARALOID EXL-2315 (trade name) manufactured by Kureha Chemical Industry Co., Ltd., in which the core and the shell were acrylic resins, respectively) was blended with 100 parts by mass of PET (TR-8550 (trade name) manufactured by Teijin Chemicals Ltd.). The resultant mixture was kneaded as described above, to obtain a resin dispersion, in which the PET was in a continuous phase and the core-shell polymer resin was in a dispersed phase. The thus-obtained resin dispersion was extruded to coat, onto a 0.4-mmφ copper wire preheated at 180° C., using a 30-mmφ extruder (extrusion conditions: 210 to 280° C.), to obtain an insulated wire of the present invention.

### Example 2

Fifteen parts by mass of a core-shell polymer resin (PARALOID EXL-2315 (trade name) manufactured by Kureha Chemical Industry Co., Ltd., in which the core and the shell were acrylic resins, respectively) was blended with 100 parts by mass of PET, to obtain a resin dispersion, in which the PET was in a continuous phase and the core-shell polymer resin was in a dispersed phase. An insulated wire of the present invention was obtained in the same manner as in Example 1, except that the thus-obtained resin dispersion was used.

### Example 3

Fifteen parts by mass of a core-shell graft copolymer resin having an epoxy functional group on the shell surface (PARALOID EXL-2314 (trade name) manufactured by Kureha Chemical Industry Co., Ltd., in which the core and the shell were acrylic resins, respectively) was blended with 100 parts by mass of PET, to obtain a resin dispersion, in which the PET was in a continuous phase and the core/shell graft copolymer resin was in a dispersed phase. An insulated wire of the present invention was obtained in the same manner as in Example 1, except that the thus-obtained resin dispersion was used.

### Comparative Example 1

The PET was extruded to coat, onto a 0.4-mmφ copper wire preheated at 180° C., using a 30-mmφ extruder (extrusion conditions: 210 to 280° C.), to obtain an insulated wire for comparison.

### Comparative Example 2

To 100 mass parts of the PET, 15 mass parts of a resin, ethylene/acrylic acid copolymer EAA (trade name, manufactured by U.S. Dow Chemicals), were mixed, to obtain a resin composition. An insulated wire for comparison was obtained in the same manner as in Comparative Example 1, except that the thus-obtained resin composition was used.

With respect to the insulated wires of the present invention and those of Comparative Examples, their properties were evaluated as follows. The results are shown in Table 1.

(1) Dielectric Breakdown Voltage

A twisted pair of any of the resultant electric wires and a copper wire was prepared, respectively, according to the sample preparing conditions of pair twisting method of JIS C 3003⁻¹⁹⁹⁹ 10. The dielectric breakdown voltage of the resultant twisted wire pair at a usual frequency of 50 Hz and a voltage rise rate of 500 V/s was measured.

(2) High-Frequency Dielectric Breakdown Voltage

A twisted pair of any of the resultant electric wires and a copper wire was prepared, respectively, according to the sample preparing conditions of pair twisting method of JIS C 3003⁻¹⁹⁹⁹ 10. The dielectric breakdown voltage of the resultant twisted wire pair at a high frequency of 3 kHz and a voltage rise rate of 50 V/s was measured.

(3) Change in Dielectric Breakdown Voltage with Lapse of Time

As an accelerated test of change in dielectric breakdown voltage with the lapse of time, any of the resultant electric wires, left at 50° C. under 90% RH for 1 week, was utilized to prepare a twisted pair of said electric wire and a copper wire, according to the sample preparing conditions of pair twisting method of JIS C 3003⁻¹⁹⁹⁹ 10. The dielectric breakdown voltage of the resultant twisted wire pair was measured.

(4) Change in Flexibility with Lapse of Time

As an accelerated test of change in flexibility with the lapse of time, it was observed whether crazing had occurred to each of the resultant electric wires left at 50° C. under 90% RH for 1 week, according to JIS C 3003⁻¹⁹⁹⁹ 7.

(5) Softening Test

Softening temperature of each of the insulated wires was measured, according to JIS C 3003⁻¹⁹⁹⁹ 11.

TABLE 1

| | | | | Comparative | Comparative |
|---|---|---|---|---|---|
| | Example (1) | Example (2) | Example (3) | Example (1) | Example (2) |
| Coating thickness (μm) | 50 | 49 | 49 | 49 | 50 |
| Dielectric breakdown | 9.2 | 9.7 | 8.0 | 9.8 | 9.2 |
| voltage (kV) at 50 Hz | | | | | |
| Dielectric breakdown | 2.2 | 2.7 | 2.8 | 1.1 | 1.5 |
| voltage (kV) at 3 kHz | | | | | |
| Dielectric breakdown | 7.5 | 8.5 | 7.8 | 5.7 | 8.6 |
| voltage [kV] at 50 Hz | | | | | |
| after leaving for 1 week | | | | | |
| at 50° C. 90% RH | | | | | |
| Crazing after leaving for | Not observed | Not observed | Not observed | Observed | Not observed |
| 1 week at 50° C. 90% RH | | | | | |
| Softening temp. (° C.) | 236 | 229 | 231 | 260 | 220 |

It can be understood from the results shown in Table 1 that the insulated wires obtained in Examples 1 to 3 can suppress degradation of dielectric breakdown voltage, which might be caused by occurrence of crazing, and they have superior values of the high-frequency dielectric breakdown voltage as compared to the insulated wires in Comparative Examples 1 or 2.

### INDUSTRIAL APPLICABILITY

The insulated wire of the present invention is preferable for use, for example, in electric and electronic devices, machinery and tools, especially, for use as a winding in these devices, machinery and tools.

Having described our invention as related to the present embodiments, it is our intention that the invention not be limited by any of the details of the description, unless otherwise specified, but rather be construed broadly within its spirit and scope as set out in the accompanying claims.

1. An insulated wire, which is coated, on a conductor, with a thin insulating layer composed of a resin dispersion,
wherein the resin dispersion comprises:
a polyester-series resin (A) in a continuous phase; and
a core-shell polymer (B) in a dispersed phase, in which the core-shell polymer (B) has a rubber-like core produced from an acrylate, a methacrylate or a mixture thereof and has an outer shell comprising a vinyl-series homopolymer or copolymer.

2. The insulated wire according to claim 1, wherein the polyester-series resin (A) is a polymer obtained by condensation reaction of a dicarboxylic acid with a diol.

3. The insulated wire according to claim 1 or 2, wherein the core-shell polymer (B) has a rubber-like core comprising an alkyl acrylate polymer, and has an outer shell comprising an alkyl methacrylate polymer.

4. The insulated wire according to claim 1 or 2, wherein the resin dispersion contains 1 to 20 mass parts of the core-shell polymer (B), to 100 mass parts of the polyester-series resin (A).
